(19) United States
(12) Patent Application Publication
(10) Pub. No.: US 2006/0098709 A1
(43) Pub. Date: May 11, 2006

(54) Infrared thermometer

(76) Inventors: Horng-Tsann Huang, Hsinchu City (TW); Chin-Huan Chen, Hsinchu City (TW); Chih-Hua Hsu, Kaohsiung City (TW); Feng-Chu Lin, Hukou Township (TW)

Correspondence Address: RABIN & BERDO, P.C., Suite 500, 1101 14 Street, N.W., Washington, DC, 20005, US

(21) Appl. No.: 11/025,046

(22) Filed: Dec. 30, 2004

(30) Foreign Application Priority Data
Nov. 9, 2004 (TW) 93134141

(51) Int. Cl. G01J 5/00

(52) U.S. Cl. 374/121

(57) ABSTRACT

An infrared thermometer includes a thermal conductor and a thermal adjuster to conduct suitable thermal flux into the sensor unit. A thermal conductive bushing is also mounted under the bottom of the sensor unit and touching the thermal conductor. The thermal fluxes conducting to the upper portion and the lower portion of the sensor unit are thus balanced suitably and quickly to remove the thermal noise and help the thermometer maintaining precise measurements from infrared radiation of the target.

### FIELD OF THE INVENTION

The invention generally relates to an infrared thermometer, and in particular relates to an infrared thermometer, such as an ear thermometer, that can easily get ready for measurement and save time of thermal balance.

### BACKGROUND OF THE INVENTION

Every time when summer, the severe acute respiratory syndrome (SARS) seems ready to make trouble. In the SARS crisis, more and more families use ear thermometers. Infrared thermometers become the front line tools of the airport quarantine personnel to prevent from intrusion of the epidemic.

As shown in FIG. 1, an ear thermometer mainly includes an infrared sensor 10 to detect temperature based on infrared radiation inside the ear canal. Besides the infrared sensor 10, there are a waveguide 22 and a heatsink 21. As shown in FIG. 2, the infrared sensor 10 is composed of a base 11, pins 12, a cover 13, a filter 14 and a sensing portion 15. The base 11 carries the sensing portion 15. The pins 12 pass through the base 11 and output the electrical voltage transduced from the infrared radiation (correspondent to the target temperature) and signals corresponding to temperature of the base 11 of the sensor. The cover 13 covers the base 11 and the sensing portion 15 and leaves a window for mounting the filter 14. The filter 14 provides a suitable filtration of a certain range of infrared ray passing to the sensing portion 15 for detecting the temperature of the target (such as the eardrum in the ear canal that represents the body temperature).

The sensing portion 15 is mainly a “thermopile” to detect the target temperature by transducing thermal radiation into electrical output. In order to assure reception of the thermal radiation of the target only, the filter 14 on the cover 13 is used to define a suitable viewing angle in which the heat (infrared radiation) from the target is transferred to the sensing portion 15.

The cover 13 is usually made of a thermal conductive material, such as metal, so that the heat conducted to the cover 13 of the sensing portion 15 is easy to be transferred to other portions and prevented from inaccurate measurement caused by interference of partial thermal unbalance. However, the cover 13 is practically made of thin metal so that partial thermal unbalance actually exists between the cover 13 and the base 11 and influences the thermopile output.

Therefore, in application, the ear thermometer 20 includes a waveguide 22 and a heatsink 21. The waveguide 22 leaves the infrared sensor 10 away from thermal contact with the heat target (ear canal) but transfers the infrared radiation. The heatsink 21 absorbs and balances the heat conducted to exterior of the infrared sensor 10 so as to prevent from partial thermal unbalance and increase the measurement accuracy. However, the waveguide 22 complicates the construction and increases the cost of the ear thermometer 20.

U.S. Pat. No. 6,076,962 discloses an infrared probe consisting of a sensor unit disposed on a sensor base and surrounded by an isolation unit to eliminate the conventional waveguide tube. The isolation unit is applied to limit the heat transmission caused by the temperature difference between the probe and the sensor unit. The isolation unit is made of thermal conductive material that can transmit the heat quickly so as to reduce the temperature measurement error. However, the isolation unit makes the sensor unit being isolated from the ambient temperature. Therefore, the infrared probe has to stay in the environment for a period of time till the probe and the sensor unit get balanced in order to achieve accurate measurements. A long balancing time is required when the ambient temperature changes largely. It causes inconvenience to the users.

### SUMMARY OF THE INVENTION

The object of the invention is to provide an infrared thermometer without using a waveguide and can save time of thermal balance to get ready for measurement easily.

An infrared thermometer according to the invention includes a shell, a thermal conductor, a sensor unit and a thermal conductive bushing. The thermal conductor and the sensor unit are located in the shell. The thermal conductor conducts suitable thermal flux into the sensor unit. The thermal conductive bushing is mounted under the bottom of the sensor unit and touching the thermal conductor. The thermal fluxes conducting to the upper portion and the lower portion of the sensor unit are thus balanced suitably and quickly to remove the thermal noise of conduction and help the thermometer maintaining precise measurements from infrared radiation of the target.

The invention can further include a thermal conducting adjuster mounted between the thermal conductor and the sensor unit to allow suitable thermal flux conducted into the sensor unit and to maintain the accuracy of measurement.

### BRIEF DESCRIPTION OF THE DRAWINGS

The invention will become more fully understood from the detailed description given hereinbelow. However, this description is for purposes of illustration only, and thus is not limitative of the invention, wherein:

FIG. 1 is a constructional view of a conventional ear thermometer;

FIG. 2 is a constructional view of a conventional infrared sensor unit;

FIG. 3 is a compositional view of an infrared thermometer of the invention;

FIG. 4 is a sectional view of an infrared thermometer of the invention;

FIGS. 5A to 5C are sectional views of other embodiments of the invention;

FIG. 6A is a partial sectional view of a shell in the invention showing a cutoff portion;

FIG. 6B is a partial sectional view of a shell in the invention showing a thermal retardant ring;

FIGS. 7A, 7B are embodiments of thermal conductive bushing in the invention; and

FIGS. 8A, 8B are embodiments of thermal conducting adjuster in the invention.

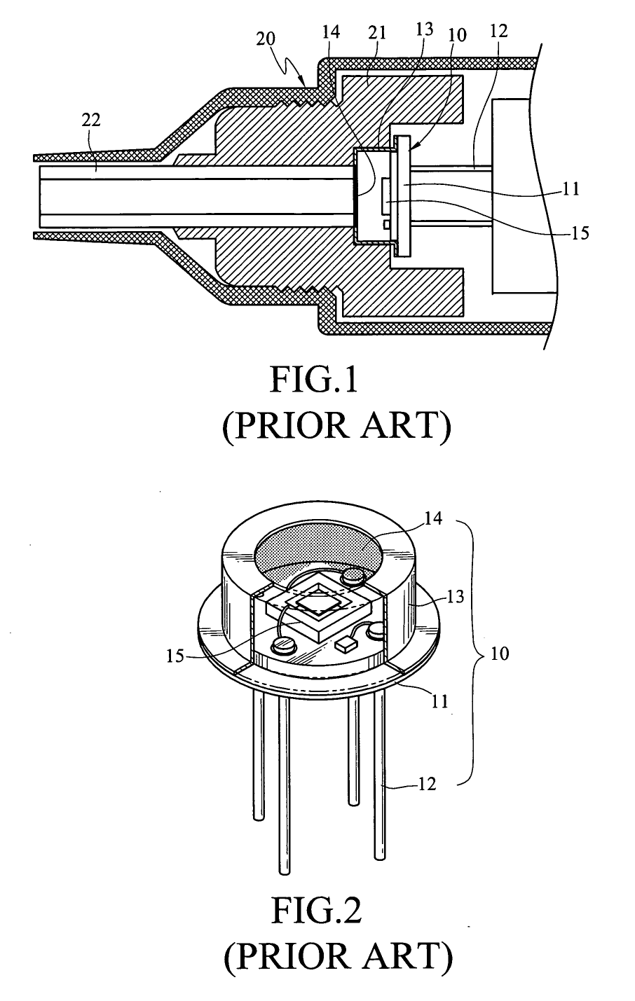

### DETAILED DESCRIPTION OF THE INVENTION

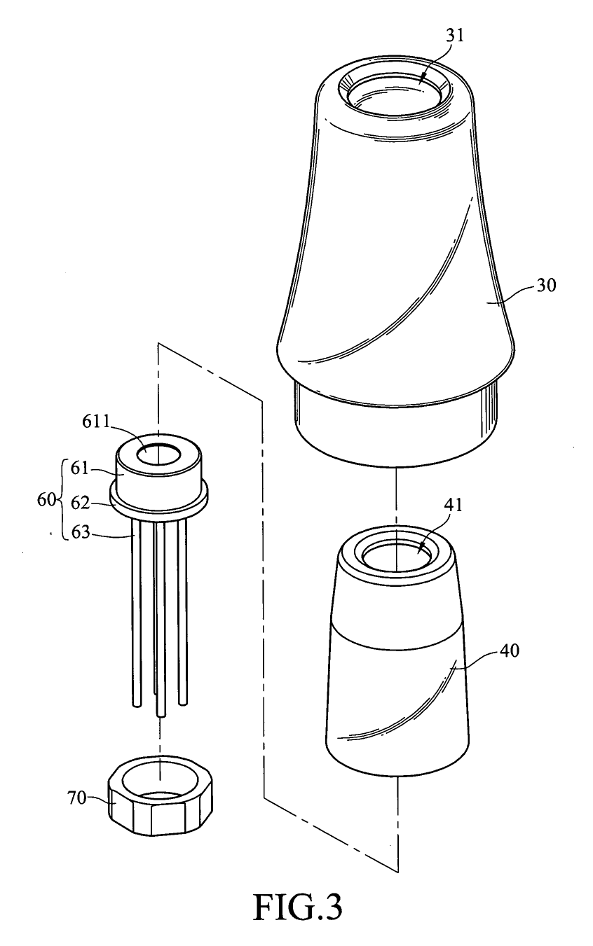

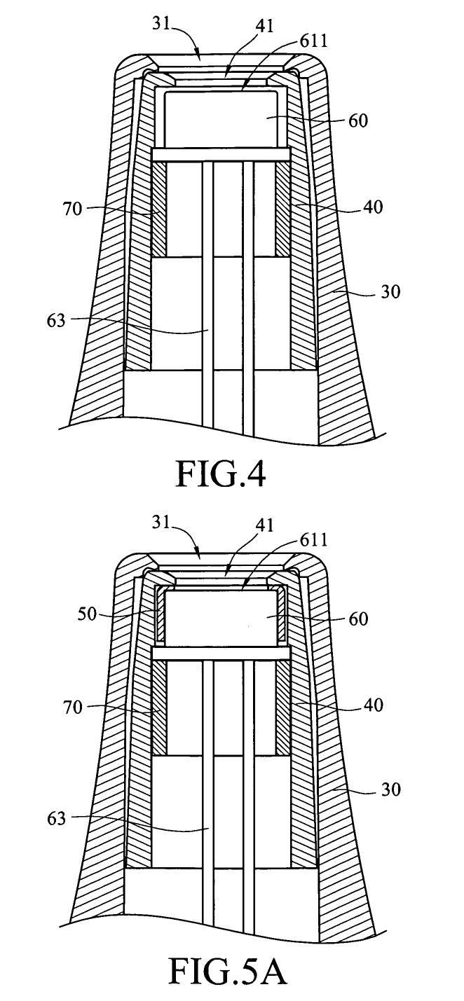

As shown in FIG. 3, an infrared thermometer according to the invention includes a shell 30, a thermal conductor 40, a sensor unit 60 and a thermal conductive bushing 70. The shape of the shell depends on the final product. For example, the shell of an ear thermometer is a probe having a smaller front end for fitting into one's ear canal (not shown in the drawing). Of course, the shell 30 can be of other shapes. The shell 30 is mainly a hollow tube having an inner space and a measuring window 31 at its front end. The thermal conductor 40 is also a tube having an inner space and an opening 41 corresponding to the measuring window 31. The thermal conductor 40 is made of thermal conductive material, located in the shell 30 and holds the sensor unit 60 for conducting suitable thermal flux into the sensor unit 60 and equalizing the temperature surrounding the sensor unit 60.

The sensor unit 60 is located inside the thermal conductor 40. The sensor unit 60 consists of a cover 61, a base 62 and output pins 63. The cover 61 has a filter window 611 (the same as that illustrated in FIG. 2 and described above). Exterior infrared radiation passes through the measuring window 31, the opening 41 and the filter window 611 to the sensing portion inside the sensor unit 60 for temperature measurement. In order to prevent the conductive thermal flux of the thermal conductor 40 from directly passing into the cover 61 of the sensor unit 60, the portion of the thermal conductor 40 surrounding the sensor unit 60 does not fully contact with the cover 61.

In prior arts of infrared thermometers, the sensor unit is isolated behind the waveguide or covered by the heatsink or the isolation unit as described above. The conventional infrared thermometers require a period of time to balance the temperature of the sensor unit with the ambient temperature for an accurate measurement. Because the temperature measurement is based on the temperature difference between the sensing portion (the infrared radiation passing through the filter window 611) and the base 62, the temperature at the upper portion of the sensor unit 60 has to be balanced with the temperature of the base 62 so as to get accurate measurements. Especially when moving the thermometer to a place where the ambient temperature changes a lot, a longer waiting time is required for the temperature of the sensor to get balanced with the ambient temperature.

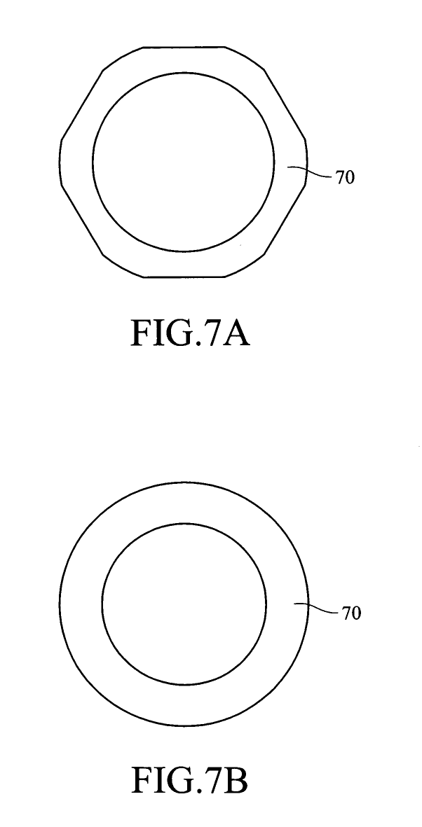

On the contrary, the infrared thermometer of the invention uses a thermal conductor 40 to hold the sensor unit 60 and conducts suitable thermal flux into the sensor unit 60 from the upper portion of the sensor unit 60. Further, a thermal conductive bushing 70 is mounted under the bottom of the sensor unit 60 and touching the base 62 and the thermal conductor 40 (the thermal conductor 40 extends longer over the sensor unit 60 so as to contact the rim of the thermal conductive bushing 70). The shape of the thermal conductive bushing 70 can be as FIG. 7A that some cutoffs are formed on the rim for partial contact only. Or, the thermal conductive bushing 70 can be a full circle as FIG. 7B for full rim contact with the thermal conductor 40.

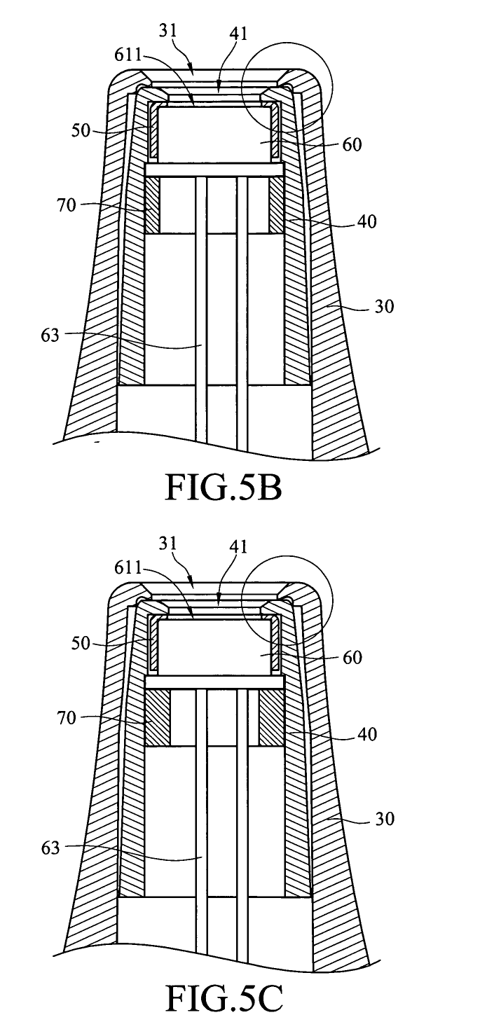

During measurement, a part of thermal flux is also conducted from the thermal conductor 40 via the thermal conductive bushing 70 to the bottom of the sensor unit 60 so as to balance with the thermal flux conducted from the thermal conductor 40 to the upper portion of the sensor unit 60, and to maintain or fast achieve the ready-for-measurement conditions. According to different balance requirements, the shape (contact area), volume or length (as shown in FIGS. 5A to 5C) of the thermal conductor 40 and the thermal conductive bushing 70 are suitably arranged. When suitably adjusting the thermal conductions of the thermal conductive bushing 70 and the thermal conductor 40 to the sensor unit 60, it can even achieve a condition that the sensor unit 60 is dynamically balanced at each measurement and maintains precise measurements from infrared radiation of the target without the need of waiting for a balance time of thermal conduction.

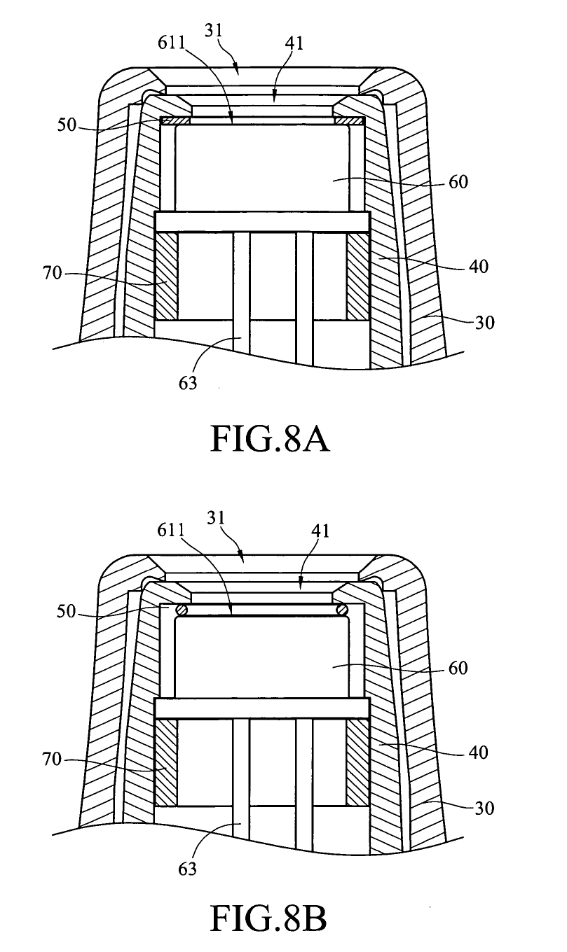

As shown in FIGS. 5A to 5C, there can further be a thermal conducting adjuster 50 mounted between the thermal conductor 40 and the sensor unit 60 to allow suitable thermal flux conducted into the sensor unit 60 and to maintain accurate measurements. The thermal conducting adjuster 50 is made of non-metal material (such as silicone rubber) or metal for a suitable thermal conductivity. The shape of the thermal conducting adjuster 50 can be a cup (as shown in FIGS. 5A to 5C), a plate (as shown in FIG. 8A) or a ring (as shown in FIG. 8B).

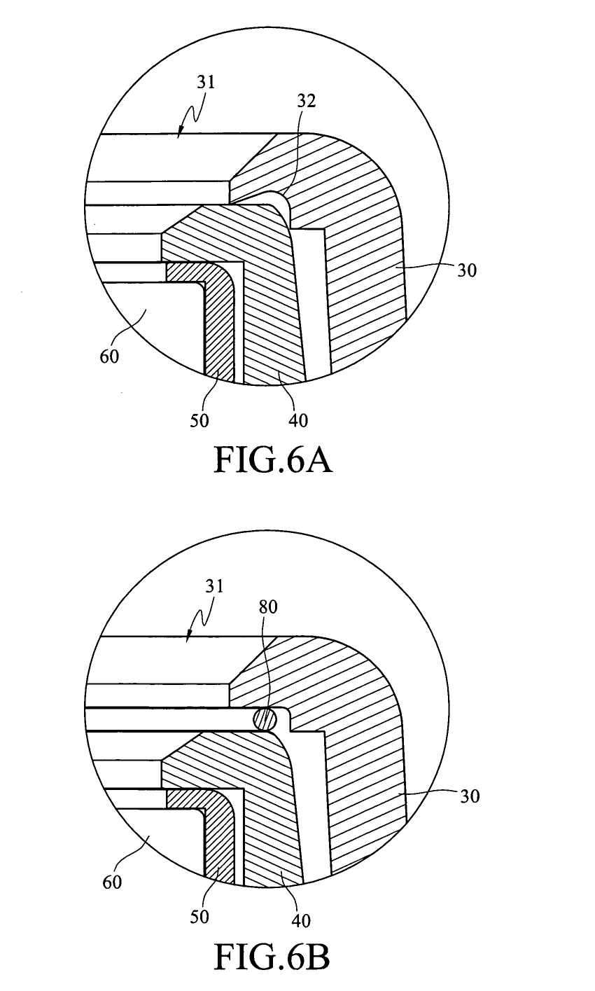

On the other hand, inside the front end of the shell 30, there can be a concave or cutoff portion 32 to decrease the contact area of the shell 30 with the thermal conductor 40 and to achieve a better thermal conduction adjusting result. The reduction of thermal conduction can also be achieved by a thermal retardant ring 80 (as shown in FIG. 6B) located between the shell 30 and the thermal conductor 40.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An infrared thermometer, comprising:
a shell, having an inner space and a measuring window at a front end;
a sensor unit, located in said shell, for detecting infrared radiation coming from a target and passing through said measuring window;
a tubular thermal conductor, made of thermal conductive material, located between said shell and said sensor unit for conducting suitable thermal flux into said sensor unit; and
a thermal conductive bushing, made of thermal conductive material, mounted under bottom of said sensor unit and touching said thermal conductor for balancing thermal fluxes conducting to upper and lower portions of said sensor unit.

2. The infrared thermometer of claim 1, wherein said thermal conductive bushing has a suitable thermal conductivity for balancing thermal fluxes conducting to lower and upper portions of said sensor unit.

3. The infrared thermometer of claim 2, wherein said thermal conductive bushing is formed with a suitable shape for said thermal conductivity.

4. The infrared thermometer of claim 2, wherein said thermal conductive bushing is formed with a suitable thickness for said thermal conductivity.

5. The infrared thermometer of claim 1, further comprises a thermal conducting adjuster mounted between said thermal conductor and said sensor unit to allow suitable thermal flux conducted into said sensor unit.

6. The infrared thermometer of claim 5, wherein said thermal conductive bushing and said thermal conducting adjuster have suitable thermal conductivity for balancing thermal fluxes conducting to lower and upper portions of said sensor unit.

7. The infrared thermometer of claim 6, wherein said thermal conductive bushing and said thermal conducting adjuster are formed with suitable shapes for said thermal conductivity.

8. The infrared thermometer of claim 6, wherein said thermal conductive bushing and said thermal conducting adjuster are formed with suitable thicknesses for said thermal conductivity.

9. The infrared thermometer of claim 5, wherein said thermal conducting adjuster is made of non-metal material.

10. The infrared thermometer of claim 5, wherein said thermal conducting adjuster is made of metal.

11. The infrared thermometer of claim 1, wherein a cutoff portion is formed on a portion inside said shell where said shell contacts with said thermal conductor so as to decrease thermal contact area of said shell with said thermal conductor.

12. The infrared thermometer of claim 1, further comprises a thermal retardant ring mounted between said shell and said thermal conductor.
